(19) United States
(12) Patent Application Publication
(10) Pub. No.: US 2023/0203606 A1
(43) Pub. Date: Jun. 29, 2023

(54) Biomass Direct Reduced Iron

(71) Applicant: Technological Resources Pty. Limited, Melbourne (AU)

(72) Inventor: Rodney James Dry, City Beach (AU)

(21) Appl. No.: 17/926,819

(22) PCT Filed: May 28, 2021
(86) PCT No.: PCT/AU2021/050526

§ 371 Date: Nov. 21, 2022

(30) Foreign Application Priority Data
May 29, 2020 (AU) 2020901772

(51) Int. Cl. C21B 13/00; C21B 13/14; C21B 13/12

(52) U.S. Cl. CPC C21B 13/0033; C21B 13/004; C21B 13/0066; C21B 13/143; C21B 13/12

(57) ABSTRACT

A process for producing direct reduced iron (“DRI”) from iron ore and biomass in a single stage fluidised bed includes injecting (a) iron ore, (b) gaseous oxygen and (c) a solid reductant including biomass into a reaction zone of the fluidized bed operating in a temperature range of 750-850#C and reducing iron ore and forming DRI in the fluidized bed and discharging DRI having a metallisation of at least 70% from the fluidised bed.

### TECHNICAL FIELD

The present invention relates to a process and an apparatus for producing direct reduced iron (“DRI”) from iron ore and biomass.

The present invention relates particularly to a process and an apparatus for producing DRI in a fluidized bed system. This DRI may be used to make hot metal, cold pig iron or steel in an electric melting furnace.

The term “direct reduced iron (“DRI”)” is understood herein to mean iron produced from the direct reduction of iron ore (in the form of briquettes, lumps, pellets, or fines) to iron by a reducing gas at temperatures below the bulk melting temperature of the solids. The extent of the conversion of iron oxide within the ore into metallic iron is referred to as “metallisation” and is measured as a percentage of the mass of metallic iron produced by conversion divided by the mass of total iron.

The present invention also relates to a process and apparatus for producing molten metal (such as cold pig iron or steel) from DRI.

### BACKGROUND

Climate change is driving a fundamental re-evaluation of future options for producing iron and steel.

Blast furnaces currently dominate virgin iron production and emit high levels of CO₂, roughly 1.8-2.0 t CO₂ per tonne of pig iron. These emissions arise from use of fossil fuels, in particular the requirement for coal (in the form of coke) as an essential feed material for a blast furnace to operate.

An alternative approach to blast furnaces is the direct reduction of iron ore in a solid state by carbon monoxide and hydrogen derived from natural gas or coal. While such plants are compatibly minor, tonnage wise, compared to blast furnaces there are quite a number of process versions. Generally, plants for the direct reduction of iron (outside of India) tend to be gas based shaft furnaces in which pellets of ore that have been hardened by a process called ‘induration’ are reduced, like the Midrex™ and HYL™ processes.

A non-pellet feed approach (although seemingly of limited commercial success) is an approach that uses fluidised bed technology, such as the Circofer™, Finmet™ and Finex™ processes. The advantage of such an approach is that fine ore can be directly charged into the process without the need for agglomeration of ore into pellets (and subsequent induration). The most successful of these processes to date is perhaps the Finex process developed by Posco of South Korea and Siemens VAI Metal Technology of Austria (now offered by Primetals Technologies). The key is a four stage, bubbling fluidized-bed-reactor system in which ore is reduced to DRI in a counter current flow by a reducing gas generated by coal gasification.

One futurist alternative to all of the above is conversion of renewable (green) energy into hydrogen (particularly in periods when wind/solar power cost is low), with subsequent production of DRI (using hydrogen) followed by smelting in an EAF to produce steel. This route has strong support (particularly in Europe) and has the potential to become a significant part of the global solution (1). However, it has limitations, such as:
1. The amount of electricity needed is high (3000-4000 kWh/t) and green power cost needs to be low (or carbon tax high) for it to become cost-effective.
2. Hydrogen consumption for DRI is likely to be steady, whilst generation is likely to be periodic (in line with availability of low-cost off-peak renewable energy). This calls for calls for significant buffering to balance supply and demand. Storage and supply of large amounts of hydrogen is a technical challenge. Underground salt caverns and exhausted natural gas reservoirs appear to show good potential. However, not all geographical locations may be amenable to this type of hydrogen storage. Moreover, suitable storage locations may not be close to iron and/or steel facilities, resulting in logistic supply challenges.
3. Only low-gangue ore types (or those able to be readily upgraded to remove gangue) can be used with the DRI/EAF combination, i.e. the iron oxide content must be high, with few impurities. The EAF will penalise high gangue ore (due to slag make), rendering them essentially uncompetitive as a DRI feed material to the EAF. This implies many of the ores currently used in blast furnaces could become sub-economic for such a process route.

It is known that sustainable biomass could be a complementary part of the solution, acting as a substitute for fossil fuels.

Burning of either fossil fuels or biomass will release CO₂ when used. However, when fast growing plants are the source of the biomass they are largely a carbon-neutral energy source (since through photosynthesis almost the same amount of CO₂ is taken up when the plants are regrown).

To date there is no large-scale commercial iron making process that uses biomass directly.

Previous attempts to insert some biomass into processes originally designed for coal (e.g. blast furnaces and coke ovens) are marginal at best and usually quite disappointing in terms of overall CO₂ impact. This is largely because the nature of biomass is vastly different to that of coal. To use biomass successfully, it is necessary to re-design the process around the fundamental nature of biomass.

Biomass can take many forms but avoiding competition with food production is a key issue. Examples of biomass that might meet such criteria include elephant grass, sugar cane bagasse, wood waste, excess straw, azolla and seaweed/macroalagae). Such biomass availability varies considerably from one geographic location to another—and will most likely be a significant factor determining the size and location of any future biomass-based iron plants (given the volume of material required and the economic challenges in transporting such material long distances).

Various lab-scale studies (2) have shown that iron ores tested by mixing the ores with biomass and heating the mixtures in a small furnace can produce DRI in a manner that appears (superficially) somewhat better than that expected from first principles. Although the reasons may not be clear, the result stands as a technical “sweet spot”. The technical challenge is how to perform this efficiently at large scale.

There are many possible approaches.

One attempt at such approach is described in International application PCT/AU2017/051163A in the name of the applicant. It involves briquetting ore and biomass, then using a furnace, such as a linear or rotary heath furnace (or a rotary kiln), to preheat the material to at least 400° C. thereby devolatilising the biomass and removing any bound water from the ore. If this pre-heat reaches around 800-900° C., ore pre-reduction is expected to reach around 40-70% under such conditions. This is followed by a microwave treatment stage (in a non-oxidising atmosphere) where the briquettes are heated to around 1000-1100° C. and reduced (using residual bio-carbon) further, with reductions typically around 90-95% and in some instances up to almost full metallisation. This DRI may then be fed to an open-arc furnace or an induction furnace to produce pig iron.

The present invention is an alternative approach to the production of DRI.

The above description is not to be taken as an admission of the common general knowledge in Australia or elsewhere.

### SUMMARY OF THE DISCLOSURE

The present invention is based on the use of a circulating fluidized bed system with biomass feed and avoids entirely an ore-biomass briquetting step. Certain biomass types which are considered poor candidates for briquetting may be particularly well suited to this process.

More particularly, the present invention is based on an inventive adaptation of the known process “Circofer” as described in references (3) and (4). These documents describe a coal-based method for production of DRI in a circulating fluidized bed (CFB) using one or more downward-facing oxygen jets to produce heat for the process whilst allowing the lower regions of the bed to maintain reduction conditions suitable for DRI production. This process has been extensively tested using coal as reductant in a pilot plant located in Frankfurt am Main, Germany.

The invention is based on a realisation that, with biomass feed, it is possible to operate with different operating parameters to the Circofer process that do not rely on the presence of significant percentages of char particles in the bed, as is required in the Circofer process. This point is discussed further below under the heading “Differences between the Invention and the Circofer Process”.

In broad terms, the invention provides a process for producing direct reduced iron (“DRI”) from iron ore and biomass in a single stage fluidised bed includes injecting (a) iron ore, (b) gaseous oxygen and (c) a solid reductant including biomass into a reaction zone of the fluidized bed operating in a temperature range of 750-850° C. and reducing iron ore and forming DRI in the fluidized bed and discharging DRI having a metallisation of at least 70% from the fluidised bed.

The term “single stage” is understood herein to mean that gas and solids are brought into contact with one another in the fluidized bed in such a way that they are mixed together in and reside at (or close to) a single, common operating temperature. Offgas and solids are subsequently removed from the fluidized bed, with offgas temperature being at least as high as that of the solids.

The invention also provides a process for producing direct reduced iron (“DRI”) from iron ore and biomass in a fluidised bed operating as a single stage, which includes:
(a) feeding iron ore into a fluidized bed having (i) a lower region which has a higher volumetric concentration of DRI relative to the rest of the bed and operates at a temperature of 750-850° C., (ii) an intermediate region which has a lower concentration of DRI and a higher concentration of char relative to the lower region, and (iii) an upper region which is relatively lean in both DRI and char,
(b) pneumatically injecting a solid reductant comprising at least 80% by weight dried biomass into the lower region of the bed (typically with the moisture content of dried biomass generally being less than about 20-30% by weight), and
(c) injecting oxygen via one or more substantially downward-facing nozzles extending into the fluidized bed above the DRI-rich region, and
   reducing iron ore and forming DRI in the fluidized bed and discharging DRI, typically having a metallisation of at least 70%, from the fluidised bed.

The term “dry weight” is understood herein to mean the weight of the biomass following its drying by a standard technique. There are potentially numerous standards for biomass, typically revolving around heating the biomass to 105° C. and measuring the before drying and after drying weights. One such standard is ISO 18134-3:2015. Sometimes, “dry weight” is referred to as “oven dried tonnes” (odt) for woody biomass.

The fluidized bed may be a segmented fluidised bed, i.e. a fluidised bed operating so that there is a gradient of the concentration of a given solid material in the fluidised bed, with a higher concentration of the solid material at the bottom of the fluidised bed, an intermediate concentration of the solid material in the middle of the fluidised bed, and a lower concentration of the solid material at the top of the fluidised bed.

The fluidized bed may be a segregating fluidised bed, i.e. a fluidised bed operating so that finer, lower density particles segregate to the top of the fluidised bed and coarser, higher density particles segregate to the bottom of the fluidised bed.

The process may include selecting operating conditions, such as feed rates, particle sizes of solid feed material, gas velocities, fluidised bed dimensions, so that the temperature in the lower region is 800-850° C.

Step (b) may include selecting the solid reductant to comprise at least 85% by weight dried biomass.

Step (b) may include selecting the solid reductant to comprise at least 90% by weight dried biomass.

The fluidized bed may be a circulating fluidized bed.

The fluidized bed may be a bubbling fluidized bed.

The process may include injecting iron ore in the form of fines.

The process may include pre-heating iron ore before injecting iron ore into the fluidized bed.

The process may include drying biomass prior to injection at a solids temperature below 250° C.

It is preferable to avoid feed rate disturbances in biomass injection. The reason for this preference is discussed further below under the heading “Differences between the Invention and the Circofer Process”.

By way of example, the process may include controlling injection of the reductant such that instantaneous deviations in mass flow are less than 15%, typically less than 10%, of the mean time-average flow rate as measured by injection lance pressure drop.

The process may include injecting the reductant in the form of a relatively free-flowing powder which is amenable to smooth pneumatic injection.

The oxygen injection step (c) may include injecting oxygen as pure oxygen or as part of air or as part of oxygen-enriched air.

The fluidized bed pressure drop from an upper face of a gas distributor of the fluidized bed to a cyclone inlet of the fluidized bed (excluding gas distributor pressure drop) may be at least 220 mbar.

The process may include injecting biomass such that a resulting plume passes through the fluidized bed with a pressure drop of least 200 mbar (from the calculated bottom of the biomass injection plume to the cyclone inlet).

The process may include further reducing DRI from the fluidized bed in a microwave furnace having a non-oxidizing atmosphere.

The process may include forming a blend of a solids containing fixed carbon material and DRI from the fluidized bed and then feeding the blend into the microwave furnace to facilitate further reduction of the DRI.

The process may further include melting DRI in an electric furnace.

The present invention also provides an apparatus for producing direct reduced iron (“DRI”) from iron ore and biomass includes a fluidized bed having a reaction zone, inlets for injecting (a) iron ore, (b) gaseous oxygen and (c) a solid reductant including biomass into the reaction zone that is adapted to operate in a temperature range of 750-850° C. for reducing iron ore and forming DRI in the fluidized bed.

The fluidized bed may include a lower region that, in use, has a higher volumetric concentration of DRI relative to the rest of the bed and operates at a temperature of 750-850° C., an intermediate region that, in use, has a lower concentration of DRI and a higher concentration of char relative to the lower region, and an upper region that, in use, is relatively lean in both DRI and char.

The apparatus may include a pneumatic system for injecting the solid reductant, for example comprising at least 80% by weight dried biomass, into the lower region of the fluidized bed.

The apparatus may include one or more than one downward-facing nozzle for injecting oxygen into the fluidized bed.

The apparatus may include a gas distribution device for injecting a fluidizing gas into the lower region of the fluidized bed.

The present invention also provides a process and an apparatus for producing molten metal (such as cold pig iron or steel) from DRI from the above-described process and apparatus for producing DRI.

### BRIEF DESCRIPTION OF THE DRAWINGS

The present invention is described further by way of example with reference to the accompanying drawings, of which:

FIG. 1 is a schematic diagram of one embodiment of a process and apparatus for producing direct reduced iron (“DRI”) from iron ore and biomass which includes a biomass-fed fluidized bed system in accordance with the invention; and

FIGS. 2-4 are process flowsheet diagrams illustrating embodiments of a process and apparatus for producing direct reduced iron (“DRI”) from iron ore and biomass in a fluidized bed as described in FIG. 1 and then producing hot metal from the DRI in accordance with the invention.

### DESCRIPTION OF EMBODIMENTS

As noted above, in broad terms, the present invention provides a process and an apparatus for producing direct reduced iron (“DRI”) from iron ore and biomass that includes a single stage fluidized bed operating in a temperature range of 750-850° C., typically 800-850° C., with injection of iron ore, gaseous oxygen and biomass into a reaction zone of the fluidized bed.

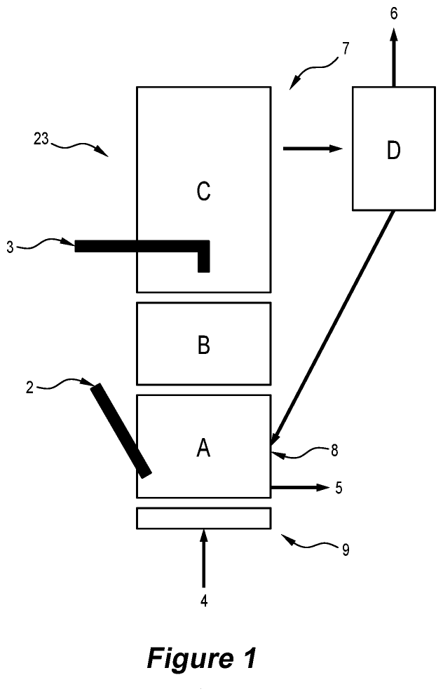

FIG. 1 is a schematic diagram of one embodiment of a fluidised bed process and a fluidised bed apparatus for DRI production according to this invention.

With reference to FIG. 1, the fluidised bed apparatus generally identified by the numeral 23 includes a fluidized bed with three zones: (i) a DRI-rich lower region (Zone A) which, in use, has a higher volumetric concentration of DRI relative to the rest of the bed and operates at a temperature of 750-850° C., (ii) an intermediate region (Zone B) which, in use, has a higher carbon content relative to the lower region and (iii) a top space (Zone C) which, in use, is relatively lean in relation to DRI and char compared to the other zones.

The fluidized bed may be either bubbling (lower gas velocity) or circulating (higher gas velocity). The fluidized bed may be any other suitable fluidized bed.

The fluidized bed includes an outlet 7 for process off-gas from the fluidized bed in an upper section of Zone C.

The fluidised bed apparatus 23 also includes a cyclone (D) that separates dust from the process off-gas from the outlet 7 and discharges a cleaned off-gas via an outlet 6. The cyclone D returns a fraction of the dust to the fluidized bed, with the returned dust being supplied to Zone A via an inlet 8.

The fluidized bed includes a suitable gas distribution device 9 for injecting a fluidizing gas 4 into a lower section of Zone A. By way of example, the gas is generally a mixture of hydrogen and carbon monoxide derived from cleaning (and reheating) process off-gas 6 discharged from the cyclone D.

The fluidized bed includes a nozzle 3 (or multiple nozzles) for injecting oxygen into Zone C of the fluidized bed. The nozzle has a vertically-extending downwardly directed outlet as shown in the Figure, noting that the injection angle may be any suitable downwardly extending angle.

The fluidized bed includes an inlet (or multiple inlets) for injecting iron ore fines 1, optionally preheated in an external arrangement (for example venturi contacting devices and additional cyclones), into in zones A and/or B of the bed. The top size of this feed iron ore fines is typically 3-6 mm. Ore may be pre-dried externally before being admitted into a preheating system.

The fluidized bed includes an inlet (or multiple inlets) for injecting dried, chopped/powdered reductant in the form of biomass 2 pneumatically into the lower region of DRI-rich Zone A. Biomass pyrolysis occurs rapidly as the material is heated, leading to a “soot lubrication” effect described below.

In use of the fluidized bed apparatus 23, iron ore fines, biomass, and oxygen are injected into the fluidized bed and the operating conditions are controlled so that Zone A of the bed is in a temperature range of 750-850° C., typically 800-850° C.

The operating conditions include, by way of example, feed rates, particle sizes of solid feed material, gas velocities, fluidised bed dimensions, so that the temperature in the lower region is 750-850° C., typically 800-850° C.

Under these conditions, iron ore is reduced to DRI through a combination of reduction gas from biomass, in-bed Boudouard reformation of CO₂ to CO, and bottom-fed reduction gas (mainly CO and H₂). DRI product 5 is removed from the lower section of the Zone A via an outlet.

Chemical reactions in Zone A are endothermic. In order to maintain the bed at a desired temperature it is necessary to supply heat. This comes from oxygen injection 3 via the downwardly-directed nozzle in a lower part of zone C. Oxygen burns locally available process gas (CO and H₂) and the resulting hot flue gas flows downwards towards Zone A. Heat transfer from this hot gas to particles in Zones A and B provides the necessary heat transfer to keep Zone A at the desired temperature.

The metallisation of the DRI produced in the fluidized bed can be adjusted as required for downstream processing options by appropriate selections of feed materials, feed rates and feed temperatures and the temperature in the fluidized bed.

The DRI product 5 may be reduced further in a second fluidized bed (not shown) or a series of successive fluidised beds (not shown) or fed directly to an electric heating or melting furnace (not shown).

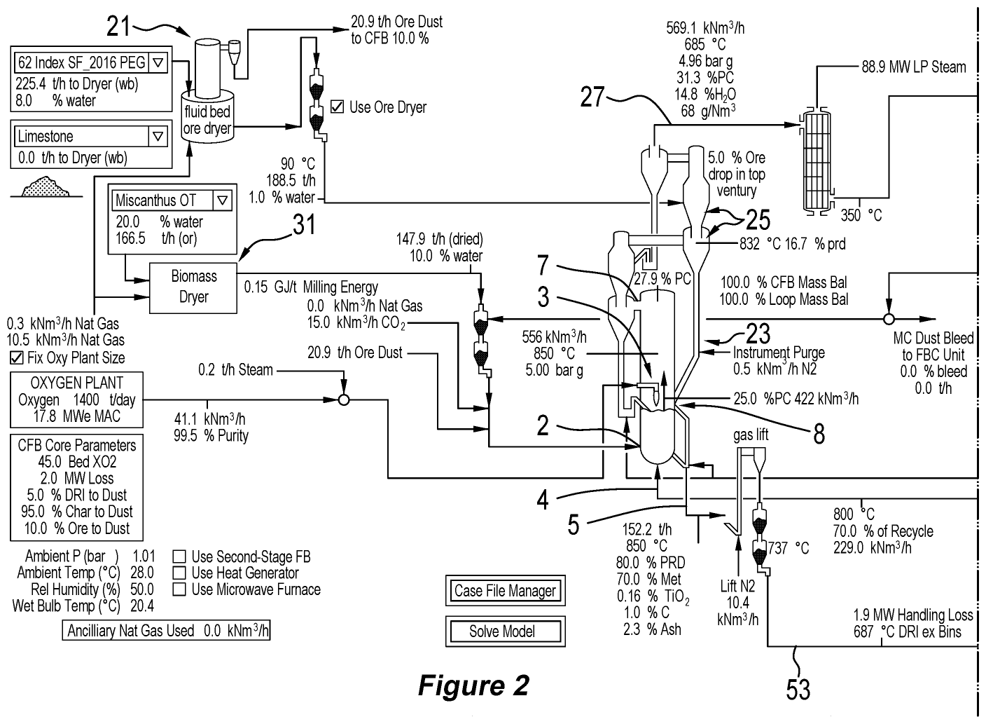

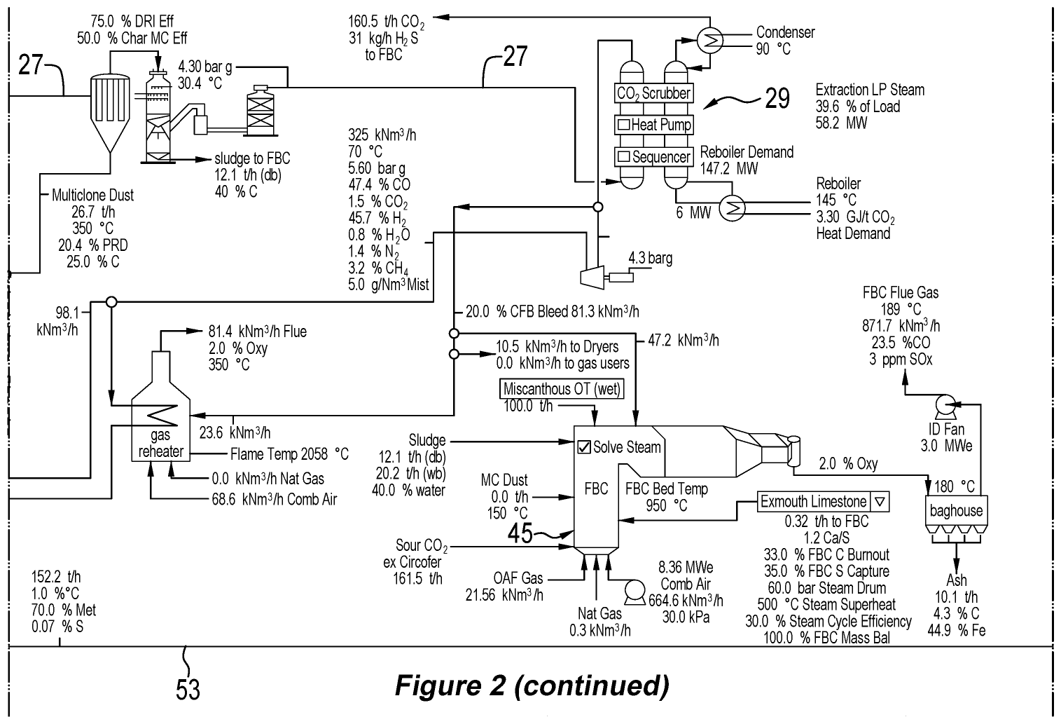

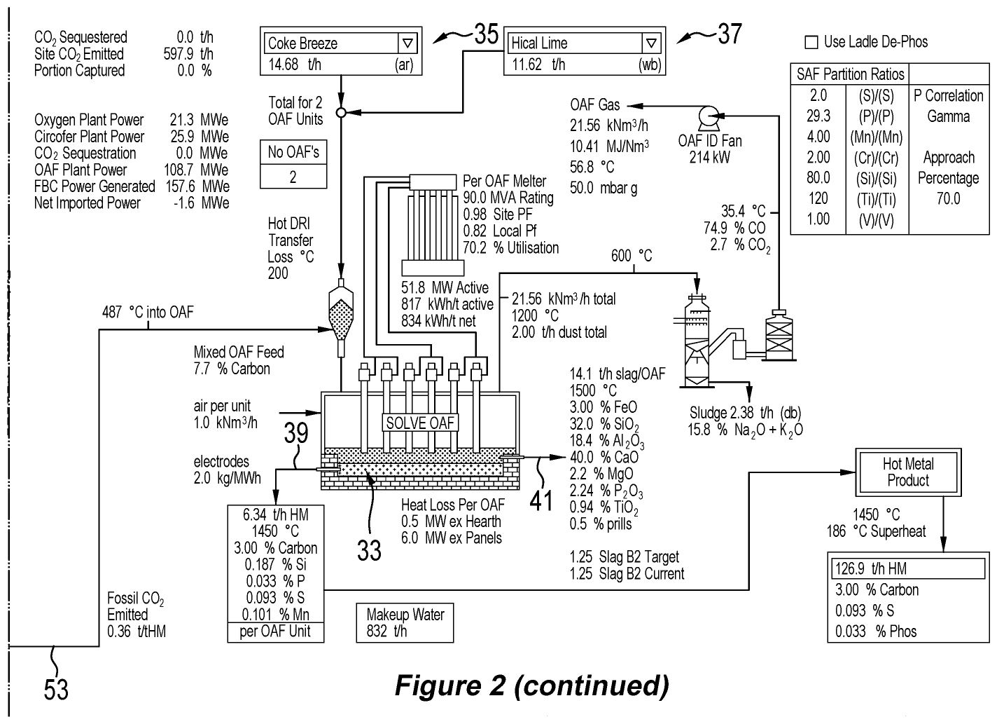

FIGS. 2-4 are process flowsheet diagrams illustrating embodiments of a process and apparatus for producing direct reduced iron (“DRI”) from iron ore and biomass in the fluidized bed reactor apparatus 23 described in FIG. 1 and then producing hot metal from the DRI in electric heating or melting furnaces in accordance with the invention.

The data in the diagrams of FIGS. 2-4 is derived from a model developed by the applicant.

The process and apparatus shown in FIG. 2 illustrates the use of a single-stage circulating fluidized bed (CFB) embodiment for the production of 1 Mt/a of pig iron.

In FIG. 2, regions A, B, C and D of the fluidized bed apparatus 23 are interconnected, with zones as indicated in FIG. 1 only to illustrate areas of differing solids and gas concentrations.

Gas and solids are considered to be mixed with each other in the fluidised bed apparatus 23 in accordance with the above definition of a single stage fluidized bed.

Iron ore at 225.4t/h (wet) is dried in a fluidized bed dryer 21 (separate and unrelated to the fluidized bed apparatus 23) before being fed into a two-stage venturi preheat system 25 where it is heated to 832° C. This pre-heated material is then fed via inlet 1 into the main circulating fluidized bed (“CFB”) described in relation to FIG. 1.

Miscanthus (elephant grass) biomass is chopped, dried in a dryer 31, and fed into the bottom of the CFB via inlet 2. As-received biomass (166.5 t/h) moisture is 20% whilst injected biomass has a moisture content of 10%.

Fluidization gas 4 (229 kNm³/h at 800° C.) is fed into the bottom of the CFB via gas distribution device 9 (see FIG. 1).

Oxygen (41.1 kNm³/h) is injected into the middle section via downward-facing oxygen nozzle 3 as shown.

Under the above conditions, iron ore fines, biomass, and oxygen injected into the CFB result in the formation of Zones A, B, C and D described in relation to FIG. 1, with Zone A being in a temperature range of 750-850° C., typically 800-850° C.

Top gas discharged via the outlet 7 from the fluidised bed passes through the two-stage ore preheat venturi preheat system 25 and is transferred as stream 27 to a scrubber assembly 29 and scrubbed to remove (i) water and (ii) carbon dioxide before 80% of it is reheated and returned to the CFB as fluidizing gas.

Product DRI (152.1 t/h) at 70% metallization is removed from the CFB via outlet 5 and transported in a line 53 to an open-arc electric melting furnace 33. It is melted in this furnace (with addition of 14.7 t/h of coke breeze 35 and 11.6 t/h calcined lime 37) to produce 126.9 t/h pig iron 39 and 28.2 t/h of slag 41.

Sludge and bleed gas from the CFB circuit are burned in a separate fluidized bed boiler 45 to generate power (157.6 MWe). Additional (untreated or simply chopped) biomass is also fed to the boiler (100 t/h) 45 in order to generate sufficient power to render the overall process power-neutral (no significant requirement for imported power). A small amount of limestone may be added to the fluidized bed boiler 45 in order to capture sulphur as CaSO₄.

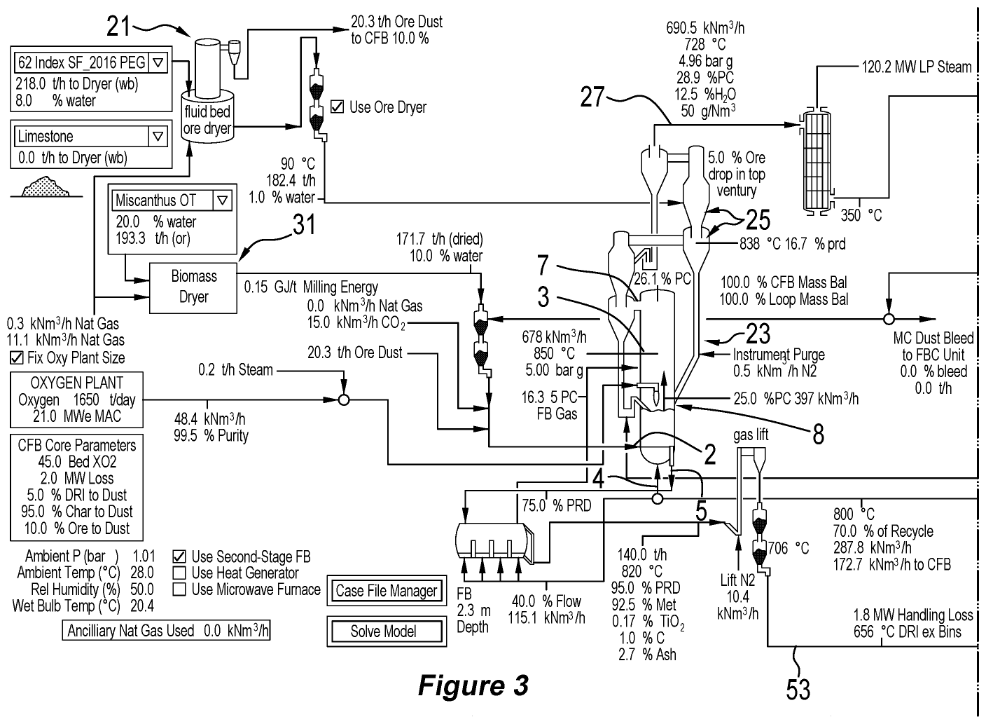

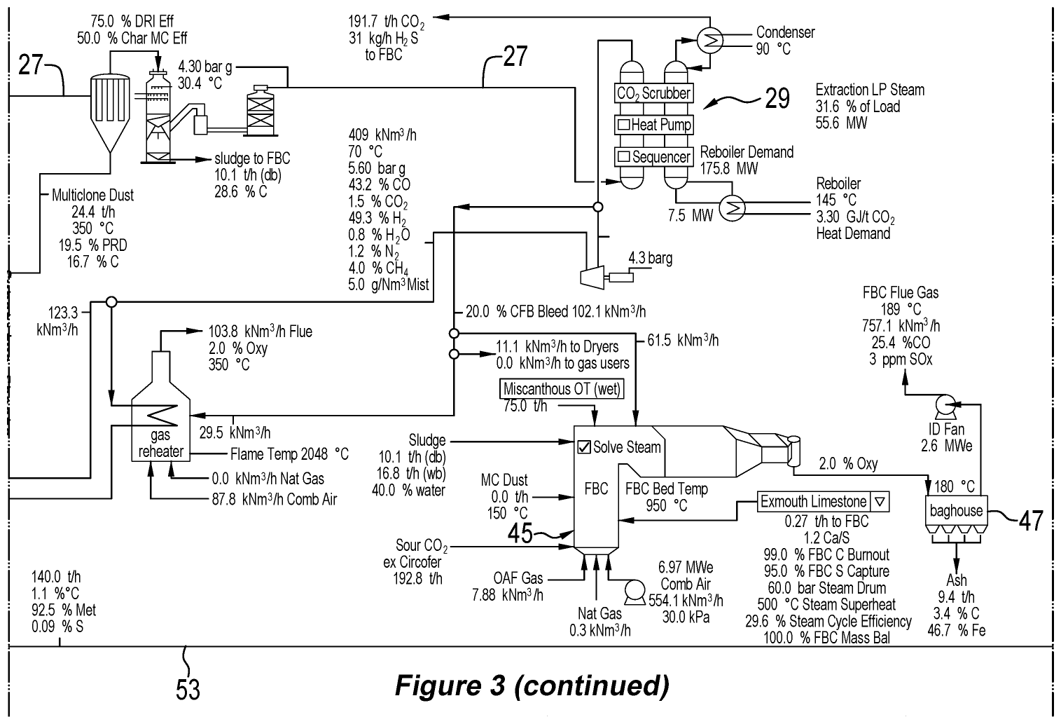

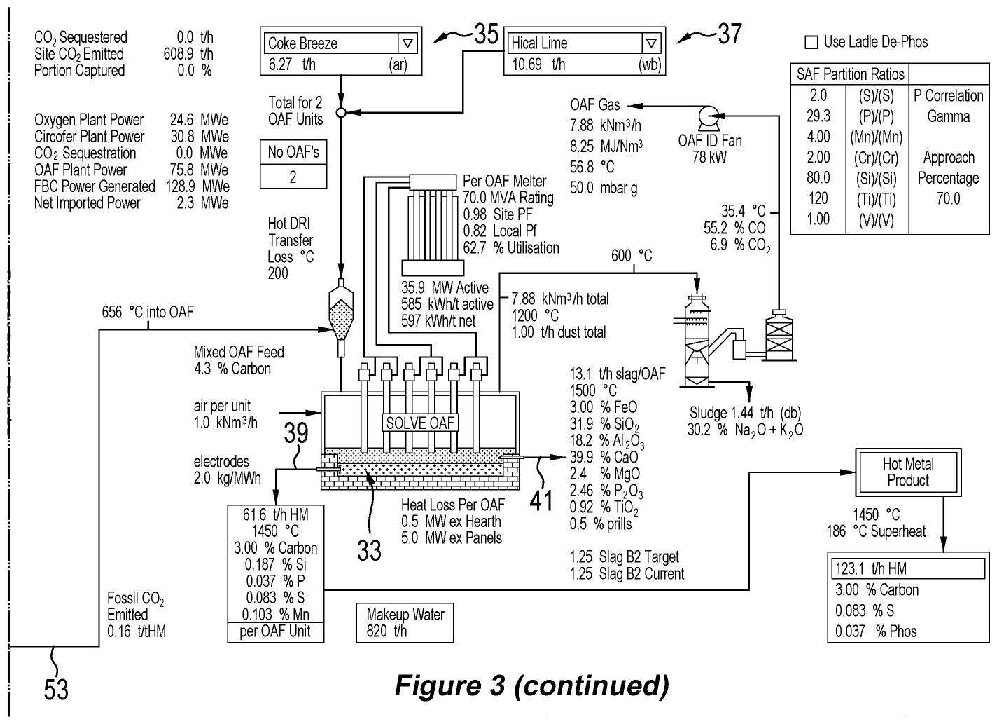

The embodiment of the process and apparatus in FIG. 3 differs from that in FIG. 2 in that DRI from the CFB is first passed to a low-velocity bubbling fluidized bed system 47 where it is further reduced to 92.5% metallization. From here it is passed to the open-arc electric melting furnace 33 described in relation to FIG. 2.

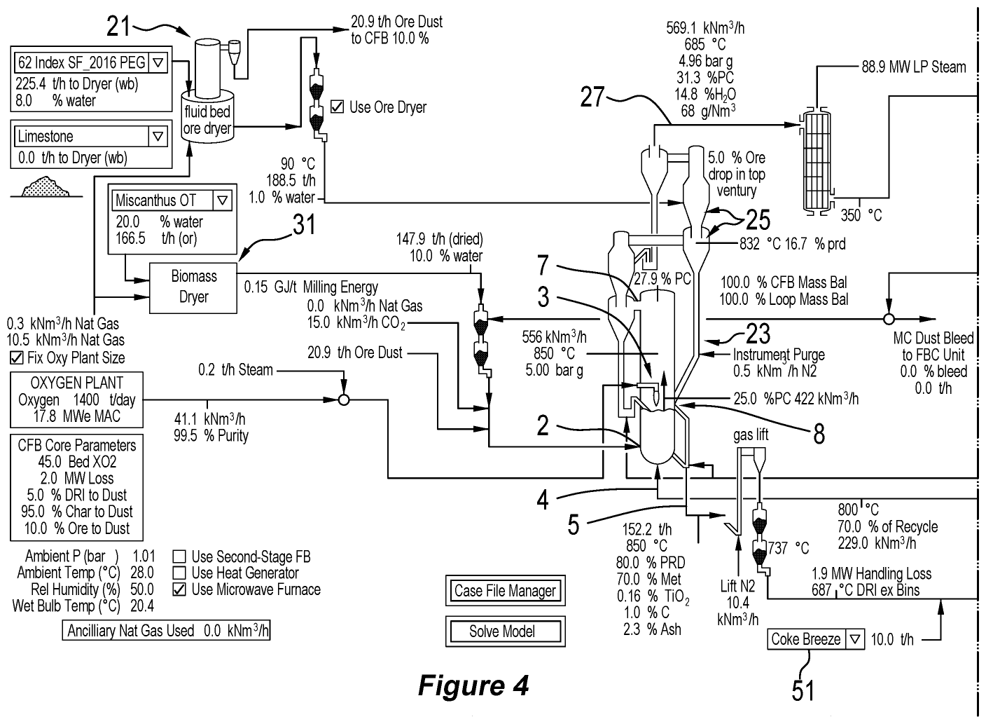

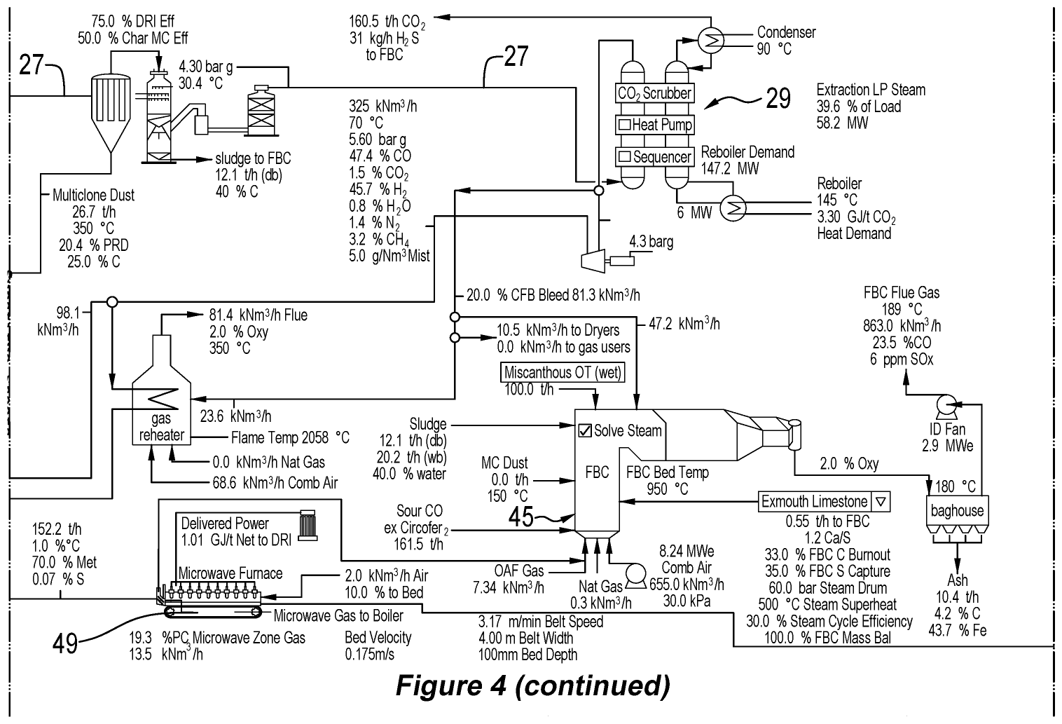

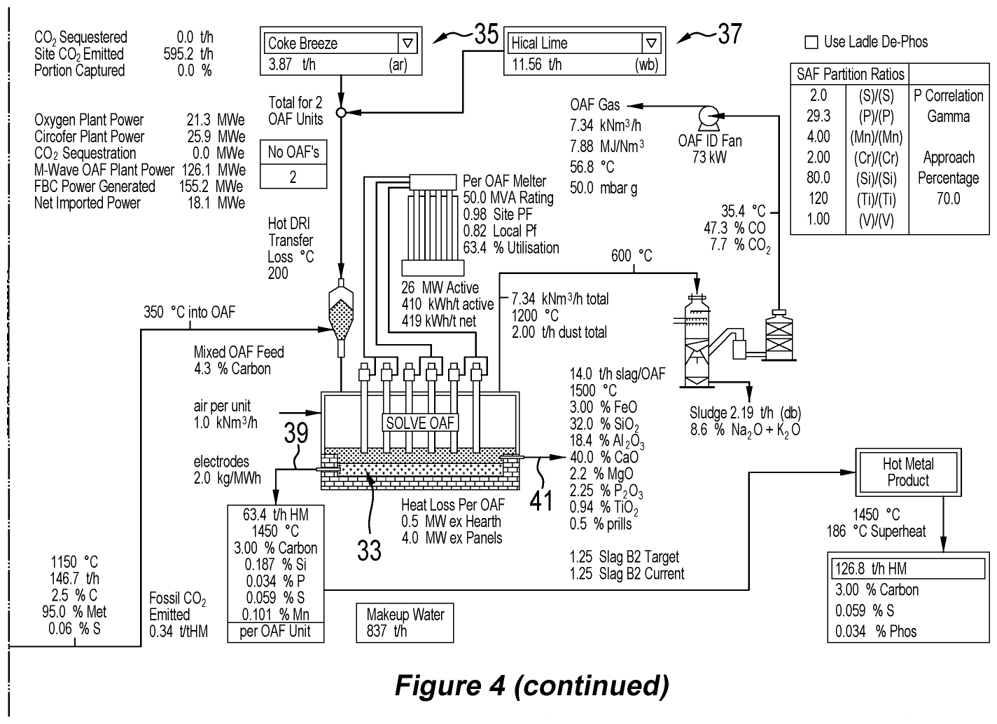

The embodiment of the process and apparatus in FIG. 4 differs from that in FIG. 2 in that DRI from the CFB is treated in a microwave furnace 49 before being fed to the open-arc electric melting furnace 33 described in relation to FIG. 2. Coke breeze 51 is added to the DRI as it enters the microwave furnace 49 in order to provide reductant.

### DIFFERENCES BETWEEN THE INVENTION AND THE CIRCOFER PROCESS

As is noted above, the invention is an inventive adaptation of the known process “Circofer” as described in references (3) and (4), noting that referring to these references is not an admission that the disclosures in the references are part of the common general knowledge in Australia or elsewhere.

Key points of difference between the Circofer process and the process of the present invention are as follows:
1. The process is based on the use of biomass, not coal.
2. The process operates at a temperature outside the operating temperature range of the Circofer process.

In the Circofer process, the core reactor operates with a fluidized bed having: (i) a sandy/granular DRI-rich lower region, (ii) a more char-rich region in an intermediate region and (iii) an upper region, i.e. top space that is lean phase (predominantly gas with char dust and a very small amount of iron-rich duct).

A key to operating the Circofer process is to inject coal at the bottom of the bed which is maintained at around 900-950° C. At this location of the bed, fluidized particles comprise (primarily) granular/sandy DRI. In the absence of bottom-bed coal injection, such particles would rapidly become sticky and form clumps, and then the process would stop. However, coal particles are injected pneumatically into this region and heated rapidly, and products of coal pyrolysis are released (volatiles, soot, reduction gas). It is thought that these volatile materials crack readily on the surface of hot fluidized DRI particles, thereby coating them with soot-like substances which provide a barrier interface that stops bulk DRI particle agglomeration. This, together with bulk separation of DRI particles from each other by char particles, is why the Circofer process is able to operate with metallised granular DRI particles at around 950° C. without sticking.

By comparison, other fluidized bed reduction processes such as the Finmet™ or Finex™ processes which use fluidized beds of granular metallized particles (without coal injection) are limited to a maximum temperature of around 750-800° C. to avoid sticking.

A coal-based Circofer process cannot operate efficiently much below about 950° C. The main reason is that it is necessary to activate the Boudouard reaction (CO₂+C→CO) in the main bed. This reaction becomes active at around 900-950° C. and, if the process is too cold, in-bed reformation of CO₂ to CO becomes too slow and DRI metallization drops.

In the Circofer process, oxygen is injected in one or more downward-facing jets at a higher elevation in the reactor vessel (well above the bottom DRI-rich region). The amount of oxygen is adjusted to provide the necessary process heat. If not positioned correctly (too low), this oxygen jet could easily burn DRI, create an accretion and stop the process. It needs to be sufficiently far away (in a fluid mechanical sense) to burn predominantly process gas (CO and H₂) plus char, with downward flow of the resulting oxygen-depleted hot gas into the DRI-rich region (for heat transfer) described above. Inevitably, there will be some finer DRI particles that are presented to the oxygen flame—these are burned to FeO and (as very hot liquid droplets) are projected back downwards into the main DRI-rich fluidized bed. On contact with larger DRI particles they fuse, solidify and are subsequently re-metallized. The result is a controlled agglomeration process in which fine iron ore particles are transformed into granular (sandy) DRI agglomerates with very low iron unit losses to dust.

Conventional thinking is that the Circofer process needs to maintain 10-30% char (as char particles) in the main bed to help physically separate DRI particles and prevent sticking at (typically) 950° C. If the injected coal produces fine char which is rapidly broken down to fines and blown out of the system, then this will lead to excessive coal consumption and reduced productivity. It is for this reason that conventional thinking effectively blocks the use of biomass—according to this logic biomass will not produce the required char particles and therefore the Circofer process using biomass will not work.

As noted above, the invention is based on the realisation that, with biomass feed, it is possible to operate with different operating parameters to the Circofer process that do not rely on the presence of significant percentages of char particles in the bed.

The applicant has realised that reliance on the presence of significant percentages of char particles in a bed for the Circofer process becomes unnecessary for the invention for the following reasons:
1. The Boudouard reaction for biomass is active at temperatures around 100° C. lower than for coal. This implies the bed could run around 800-850° C. and still produce sufficient in-bed CO₂ reformation to CO.
2. With the main bed at 800-850° C., the DRI particles will be inherently less sticky than they would be in a normal Circofer system.
3. Cracking and soot lubrication to coat particles (and avoid stickiness) can be boosted by making the DRI-rich part of a bed deeper than it would otherwise be in a Circofer process, by injecting biomass at the very bottom and ensuring biomass feed has minimal feed rate deviations in time. In the Circofer process, the bottom bed residence-time (as measured by lower dense-bed vertical height divided by superficial gas velocity) is typically around 1 second. For the process of the invention, this residence-time would be roughly 1.5-2 times this (roughly 1.5-2.0 second residence-time on the same basis). In practical terms this means the lower bed is physically about 1.5-2 times deeper and pressure drop is correspondingly higher.

Pyrolysis of coal and biomass are different. Given the higher moisture content of biomass, typically greater in-bed residence time is needed to achieve the necessary cracking (and bed lubrication). This is why a deeper DRI-rich bed (with higher fluidized bed pressure drop) is typically needed.

To maximise the effect of soot lubrication, it is also preferable with the invention to avoid feed rate disturbances in biomass injection. Soot coatings on DRI particles are a transient phenomenon, with surface char being used up (via the Boudouard reaction) as part of iron ore reduction. DRI particles need to be continuously resupplied with new surface soot/char coatings in order to avoid “naked iron” surfaces which are much more prone to sticking. The transient nature of these coatings means that any interruption in biomass feed may lead to “naked iron” in a very short time and the process will be compromised. Smooth, i.e. uninterrupted, biomass feed is therefore preferred.

The key factors to consider in any apparatus/process in accordance with the invention to minimise disturbances in feed rate injection are feeder mechanics: (feeder type, lance arrangement, conveying conditions, biomass feed granulometry and moisture content).

Normally, industrial-scale injection systems are not designed to be completely smooth because (i) this is generally more-costly and (ii) the processes in question are usually able to tolerate some degree of variability without major consequences. In this case, however, tolerance is low and extra attention will be advisable in this regard.

Many modifications may be made to the embodiments described above without departing from the spirit and scope of the invention.

By way of example, whilst the fluidized bed in the embodiment described in relation to FIG. 1 is a segregated fluidized bed, the invention is not so limited and extends to any suitable type of fluidized bed.

By way of further example, the invention is not limited to the embodiments of the process and apparatus for producing direct reduced iron (“DRI”) in accordance with the invention shown in FIGS. 2-4.

By way of further example, whilst the embodiments described in relation to FIGS. 2-4 operate with miscanthus (elephant grass) as the biomass, the invention is not so limited and extends to the use of any suitable biomass.

By way of further example, whilst the embodiments described in relation to FIGS. 2-4 operate with fluidization gas at a flow rate of 229 kNm³/h at a temperature of 800° C., the invention is not so limited and extends to any suitable flow rate and temperature of fluidisation gas.

By way of further example, whilst the embodiments described in relation to FIGS. 2-4 operate with oxygen injection at 41.1 kNm³/h, the invention is not so limited and extends to any suitable flow rate.

### REFERENCES

1. Vogl, Vet al, Assessment of hydrogen direct reduction for fossil-free steelmaking, Journal of Cleaner production 203 (218) 736-745

2. Strezov, V, Iron ore reduction using sawdust: experimental analysis and kinetic modelling, renewable Energy 31(12) 1892-1905, October 2006

3. A Orth, H Eichberger, D Philp and R Dry, US Patent Application US2008/0210055 A1, Sep. 4, 2008

4. A Orth, H Eichberger, D Philp and R Dry, World Intellectual Property Organisation International Publication Number WO 2005/116280 A1

1. A process for producing direct reduced iron (“DRI”) from iron ore and biomass in a single stage fluidised bed includes injecting (a) iron ore, (b) gaseous oxygen and (c) a solid reductant including biomass into a reaction zone of the fluidized bed operating in a temperature range of 750-850° C. and reducing iron ore and forming DRI in the fluidized bed and discharging DRI having a metallisation of at least 70% from the fluidised bed.

2. A process for producing direct reduced iron (“DRI”) from iron ore and biomass in a fluidised bed operating as a single stage fluidised bed which includes:
(a) feeding iron ore into the fluidized bed, the fluidised bed having (i) a lower region which has a higher volumetric concentration of DRI relative to the rest of the bed and operates at a temperature of 750-850° C., (ii) an intermediate region which has a lower concentration of DRI and a higher concentration of char relative to the lower region, and (iii) an upper region which is relatively lean in both DRI and char,
(b) pneumatically injecting a solid reductant comprising at least 80% by weight dried biomass into the lower region of the bed, and
(c) injecting oxygen via one or more downward-facing nozzles extending into the fluidized bed above the DRI-rich region, and
reducing iron ore and forming DRI in the fluidized bed and discharging DRI from the fluidised bed.

3. The process according to claim 1 wherein the fluidized bed is a circulating fluidized bed or a bubbling fluidized bed.

4. The process according to claim 2 wherein the fluidized bed is a circulating fluidized bed or a bubbling fluidized bed.

5. The process defined in claim 2 includes feeding iron ore in the form of fines into the fluidized bed.

6. The process defined in claim 2 includes pre-heating iron ore before feeding iron ore into the fluidized bed.

7. The process defined in claim 2 includes drying biomass at a solids temperature below 250° C. prior to injecting biomass into the fluidized bed.

8. The process defined in claim 2 includes controlling injection of the reductant such that instantaneous deviations in mass flow are less than 15% of the mean time-average flow rate as measured by injection lance pressure drop.

9. The process defined in claim 2 includes injecting the reductant in the form of a free-flowing powder which is amenable to smooth pneumatic injection.

10. The process according to claim 2 wherein a fluidized bed pressure drop from an upper face of a gas distributor of the fluidized bed to a cyclone inlet of the fluidized bed (excluding gas distributor pressure drop) is at least 220 mbar.

11. The process according to claim 2 includes injecting biomass such that a resulting plume passes through the fluidized bed with a pressure drop of least 200 mbar from the calculated bottom of the biomass injection plume to the cyclone inlet.

12. The process defined in claim 2 includes further reducing DRI from the fluidized bed in a microwave furnace having a non-oxidizing atmosphere.

13. The process according to claim 12 includes forming a blend of a solid containing fixed carbon material and DRI from the fluidized bed and then feeding the blend into the microwave furnace to facilitate further reduction of the DRI.

14. The process defined in claim 2 further includes melting DRI in an electric furnace.

15. An apparatus for producing direct reduced iron (“DRI”) from iron ore and biomass includes a fluidized bed having a reaction zone, inlets for injecting (a) iron ore, (b) gaseous oxygen and (c) a solid reductant including biomass into the reaction zone that is adapted to operate in a temperature range of 750-850° C. for reducing iron ore and forming DRI in the fluidized bed.

16. The apparatus defined in claim 15 wherein the fluidized bed includes a lower region that, in use, has a higher volumetric concentration of DRI relative to the rest of the bed and operates at a temperature of 750-850° C., an intermediate region that, in use, has a lower concentration of DRI and a higher concentration of char relative to the lower region, and an upper region that, in use, is relatively lean in both DRI and char.

17. The apparatus defined in claim 16 includes a pneumatic system for injecting the solid reductant into the lower region of the fluidized bed.

18. The apparatus defined in claim 17 includes one or more than one downward-facing nozzle for injecting oxygen into the fluidized bed.

19. The apparatus defined in claim 18 includes a gas distribution device for injecting a fluidizing gas into the lower region of the fluidized bed.
